(19) United States
(12) Patent Application Publication
(10) Pub. No.: US 2025/0313758 A1
(43) Pub. Date: Oct. 9, 2025

(54) AIR LANCE APPARATUS, SYSTEMS, AND METHODS

(71) Applicant: OXBOW CALCINING LLC, West Palm Beach, FL (US)

(72) Inventor: Sanjiv Dhanjal, Conroe, TX (US)

(21) Appl. No.: 19/057,672

(22) Filed: Feb. 19, 2025

Related U.S. Application Data
(60) Provisional application No. 63/573,551, filed on Apr. 3, 2024.

(51) Int. Cl. C10B 57/00; C01B 32/05; C10B 55/00; F27B 7/36; F27D 3/16; F27D 9/00

(52) U.S. Cl. CPC C10B 57/005; C01B 32/05; F27B 7/362; F27D 3/16; F27D 9/00; C10B 55/00; F27B 2007/365; F27D 2003/169; F27D 2009/0013; F27M 2003/03

(57) ABSTRACT

The present disclosure provides, inter alia, an apparatus, system, and/or method for reducing fuel consumption (e.g., natural gas) in a rotary kiln. In some embodiments, reduced fuel consumption is achieved by injection of air from an air lance into a bed of calcining material in a kiln.

### CROSS REFERENCE TO RELATED APPLICATIONS

The present application claims benefit of U.S. Provisional Patent Application Ser. No. 63/573,551, filed on Apr. 3, 2024, which application is incorporated by reference herein in its entirety.

### BACKGROUND

Petroleum coke (petcoke) is a byproduct of the oil refining process. As refineries worldwide seek to operate more efficiently and extract more gasoline and other high value fuels from each barrel of crude oil, a solid carbon material known as petcoke is produced. The physical and chemical characteristics of petcoke are a function of the crude oil and refining technology used by the refinery. Physically, petcoke can be hard or relatively soft. It can resemble large sponges with numerous pores, or it can resemble small spheres, ranging in size from a grain of sand to a large marble. Chemically, petcoke can include a variety of elements and metals in a wide range of concentrations. Depending on these physical and chemical characteristics, petcoke is typically used either in an energy application as a source of British Thermal Units (BTUs), or in an industrial application as a source of carbon.

Calcining of petcoke is commonly performed in a rotary kiln into which green petroleum coke in particulate form is fed at one end and calcined product falls out at the other end. During the calcining process in the kiln, high temperature drives off volatile compounds and moisture in the green coke, and shrinks it to achieve a desired density. The calcining process requires adequate heating to achieve a high production rate, while preferably minimizing or eliminating combustion of the carbon in the petcoke itself. The green coke entering the feed end of the tubular kiln flows down the kiln at a rate that depends, in large part, on the slope of the kiln drum, the diameter of the kiln drum, and on the speed of rotation of the kiln drum.

It is common to supply heat to the petcoke by firing with oil or natural gas burners directly into the lower end of the kiln. The combusted natural gas or oil (i.e. from the flame of burned natural gas or oil) are projected into the kiln, where the hot gases flow up the kiln as a countercurrent to the descending bed of petcoke. Additional heat may be obtained by burning the volatile compounds driven from the petcoke by providing air for the combustion, typically by complex blowers mounted on the exterior of (and in some cases rotating with) the kiln drum.

A substantial fraction of the cost of calcined petcoke production is attributed to the fuel for the oil or natural gas burner, and providing/maintaining a complex blower system. Thus, there exists a need for a simplified way of introducing air into the rotary kiln and reducing the amount of fuel required to maintained optimal temperature.

### SUMMARY OF THE DISCLOSURE

According to some aspects, the present disclosure provides an apparatus, system, and/or method for reducing fuel consumption (e.g., natural gas) in a rotary kiln. In some embodiments, reduced fuel consumption is achieved by injection of air from an air lance into a bed of calcining material in a kiln.

In some embodiments, a system for reducing gas consumption in a rotary kiln comprises an inclined drum having an upper end and a lower end, the drum configured to rotate around an axis and convey a bed of material from the upper end to the lower end along the axis; and an air lance comprising a wall defining an interior space, a first end, and a second end, the first end of the air lance positioned proximate to the bed of material and effective to inject air from the interior space into the bed of material, the second end positioned distal to the bed of material and effective to transfer air to the interior space; wherein the first end of the air lance is about 0 inches to 18 inches from the center of the bed of material. In some embodiments, the air lance is water cooled. In some embodiments, the first end of the air lance is effective to receive air at a pressure of about 10-30 psig. In some embodiments, the first end of the air lance is effective to receive air at a pressure of about 20 psig. In some embodiments, the air lance comprises one or more bellows located in the interior space of the air lance and/or a constriction of the interior space at the first end. In some embodiments, the air lance is effective to inject air into the bed of material while the inclined drum rotates. In some embodiments, the injection of air into the bed of material is effective to reduce the amount of gas required to calcine the bed of material by greater than 10% relative to the amount of gas required to calcine without injection of air. In some embodiments, the injection of air into the bed of material is effective to reduce the amount of gas required to calcine the bed of material by greater than 15% relative to the amount of gas required to calcinate without injection of air. In some embodiments, the injection of air into the bed of material is effective to reduce the amount of gas required to calcinate the bed of material by greater than 20% relative to the amount of gas required to calcine without injection of air. In some embodiments, the air is atmospheric air.

In some embodiments, the air lance comprises a water inlet, walls defining a second interior space, and a water outlet, wherein the second interior space is effective to receive water from the water inlet and emit water from the water outlet. In some embodiments, the water cooled air lance is cooled with approximately 13 gallons per minute of water.

In some embodiments, the inclined drum is effective to drop material from the bed of material out of the inclined drum after being contacted with the injected air. In some embodiments, the system further comprises a heat source positioned inside the drum, wherein the heat source is effective to calcine the bed of material. In some embodiments, the heat source is a flame fueled by a gas and air mixture. In some embodiments, the bed of material is petroleum coke.

In some embodiments, the air lance extends into the rotary kiln by at least 5 feet. In some embodiments, the air lance extends into the rotary kiln by at least 5.5 feet. In some embodiments, the air lance extends into the rotary kiln by at least 6 feet. In some embodiments, the air lance extends into the rotary kiln by up to 8 feet.

According to some aspects, the present disclosure provides an apparatus for reducing gas consumption in a rotary kiln comprising: an inclined drum having an upper end and a lower end, the drum configured to rotate around an axis and convey a bed of material from the upper end to the lower end along the axis; and an air lance comprising a wall defining an interior space, a first end, and a second end, the first end of the air lance positioned proximate to the bed of material and effective to inject air from the interior space into the bed of material, the second end positioned distal to the bed of material and effective to transfer air to the interior space; wherein the first end of the air lance is about 0 inches to 18 inches from the where the calcined petroleum coke falls out of the rotating drum. In some embodiments, the bed of material is petroleum coke.

In some embodiments, the air lance is water-cooled. In some embodiments, the first end of the air lance is effective to receive air at a pressure of about 10-30 psig. In some embodiments, the first end of the air lance is effective to receive air at a pressure of about 20 psig. In some embodiments, the air lance comprises one or more bellows located in the interior space of the air lance. In some embodiments, the air lance comprises a constriction of the interior space at the first end. In some embodiments, the air lance comprises a water inlet, walls defining a second interior space, and a water outlet, wherein the second interior space is effective to receive water from the water inlet and emit water from the water outlet. In some embodiments, the air lance is effective to inject air into the bed of material while the inclined drum rotates. In some embodiments, the inclined drum is effective to drop material from the bed of material out of the inclined drum after being contacted with the injected air.

In some embodiments, the apparatus as disclosed herein comprises a heat source positioned inside the drum, wherein the heat source is effective to calcine the bed of material. In some embodiments, the heat source is a flame fueled by a gas and air mixture. In some embodiments of the apparatus disclosed herein, the injection of air into the bed of material is effective to reduce the amount of gas required to calcine the bed of material by greater than 10% relative to the amount of gas required to calcine without injection of air. In some embodiments, the injection of air into the bed of material is effective to reduce the amount of gas required to calcine the bed of material by greater than 15% relative to the amount of gas required to calcine without injection of air. In some embodiments, the injection of air into the bed of material is effective to reduce the amount of gas required to calcine the bed of material by greater than 20% relative to the amount of gas required to calcine without injection of air. In some embodiments, the air is atmospheric air.

In some embodiments, the apparatus as disclosed herein comprises a water-cooled air lance cooled with approximately 13 gallons per minute of water. In some embodiments, the air lance extends into the rotary kiln by at least 5 feet. In some embodiments, the air lance extends into the rotary kiln by at least 5.5 feet. In some embodiments, the air lance extends into the rotary kiln by at least 6 feet. In some embodiments, the air lance extends into the rotary kiln by up to 8 feet.

According to some aspects, the present disclosure provides a method of reducing gas consumption of a rotary kiln, the method comprising: providing an air lance proximate to an inclined drum, wherein the inclined drum comprises an upper end and a lower end and is configured to rotate around an axis to convey a bed of material from the upper end to the lower end along the axis; and wherein the air lance comprises a wall defining an interior space, a first end, and a second end, the first end of the air lance positioned proximate to the bed of material and effective to inject air from the interior space into the bed of material, the second end positioned distal to the bed of material and effective to transfer air to the interior space, wherein the first end of the air lance is about 0 inches to 18 inches from where the calcined petroleum coke falls out of the rotating drum; and injecting air from the air lance into the bed of material while simultaneously rotating the inclined drum to convey the bed of material from the upper end to the lower end along the axis. In some embodiments, the bed of material is petroleum coke.

In some embodiments, the method disclosed herein comprises the step of water cooling the air lance. In some embodiments, the first end of the air lance is effective to receive air at a pressure of about 10-30 psig. In some embodiments, the first end of the air lance is effective to receive air at a pressure of about 20 psig. In some embodiments, the air lance comprises one or more bellows located in the interior space of the air lance. In some embodiments, the air lance comprises a constriction of the interior space at the first end. In some embodiments, the constriction is between ¼ inch and 1 inch wide. In some embodiments, the constriction is between ¼ inch and 1 inch long. In some embodiments, the constriction is as wide as it is long.

In some embodiments, the air lance comprises interior walls defining a frustoconical shape at the interior of the first end. In some embodiments, the narrow end of the frustoconical shape is between ¼ inch and 1 inch wide. In some embodiments, the overall length of the frustoconical shape is between 2 inches and 8 inches. In some embodiments, the opening from which air exits the first end is about 2 inches.

In some embodiments, the air lance comprises a water inlet, walls defining a second interior space, and a water outlet, wherein the second interior space is effective to receive water from the water inlet and emit water from the water outlet. In some embodiments, the inclined drum is effective to drop material from the bed of material out of the inclined drum after being contacted with the injected air.

In some embodiments, the method disclosed herein further comprises the step of providing a heat source inside the drum, wherein the heat source is effective to calcine the bed of material. In some embodiments, the heat source is a flame fueled by a gas and air mixture. In some embodiments, the injection of air into the bed of material is effective to reduce the amount of gas required to calcine the bed of material by greater than 10% relative to the amount of gas required to calcine without injection of air. In some embodiments, the injection of air into the bed of material is effective to reduce the amount of gas required to calcine the bed of material by greater than 15% relative to the amount of gas required to calcine without injection of air. In some embodiments, the injection of air into the bed of material is effective to reduce the amount of gas required to calcine the bed of material by greater than 20% relative to the amount of gas required to calcine without injection of air. In some embodiments, the air is atmospheric air.

In some embodiments, the method disclosed herein further comprises the step of water-cooling the air lance, wherein the water-cooled air lance is cooled with approximately 13 gallons per minute of water.

In some embodiments of the method disclosed herein, the air lance extends into the rotary kiln by at least 5 feet. In some embodiments, the air lance extends into the rotary kiln by at least 5.5 feet. In some embodiments, the air lance extends into the rotary kiln by at least 6 feet, where the calcined petroleum coke falls out of the rotating drum.

### BRIEF DESCRIPTION OF THE DRAWINGS

FIG. 1A shows a side view of an apparatus and system according to one embodiment of the present disclosure. The rotatable inclined drum with bed of material, air lance, and kiln hood (104) is shown according to some embodiments disclosed herein.

FIG. 1B shows a cross-sectional side view of an apparatus and system according to one embodiment of the present disclosure. The inclined drum with bed of material is shown with approximate location of air lance tip relative to the bed of material according to some embodiment disclosed herein.

FIG. 2A shows a perspective view of an air lance according to one embodiment of the present disclosure.

FIG. 2B shows a cross-sectional side view of an air lance according to one embodiment of the present disclosure.

FIG. 2C shows a cross-sectional side view of one end of an air lance according to one embodiment of the present disclosure.

FIG. 2D shows a cross-sectional side view of one end of an air lance according to one embodiment of the present disclosure.

FIG. 2E shows a cross-sectional front view of an air lance according to one embodiment of the present disclosure.

FIG. 2F shows a cross-sectional side view of one end of an air lance according to one embodiment of the present disclosure.

FIG. 2G shows flat bar used to guide cool water along length of air lance to cool it effectively. The water is guided to the tip of the lance, turns 180 degrees, and travels back along the length of the lance to the discharge pipe.

FIG. 3A shows a cross-sectional side view of an air lance according to one embodiment of the present disclosure.

FIG. 3B shows a cross-sectional front view of an air lance according to one embodiment of the present disclosure.

FIG. 3C shows a cross-sectional side view of an air lance according to one embodiment of the present disclosure.

FIG. 3D shows a cross-sectional front view of an air lance according to one embodiment of the present disclosure.

FIG. 4 shows data of gas consumption with and without the use of the air lance according to one embodiment of the present disclosure.

FIG. 5 shows data of gas consumption with and without the use of the air lance according to one embodiment of the present disclosure.

FIG. 6 shows certain embodiments of the nozzle of the air lance as disclosed herein.

FIG. 7 shows average weekly specific gas usage with and without use of air lance according to one embodiment of the present disclosure.

### DETAILED DESCRIPTION

According to some aspects, the present disclosure provides an apparatus, system, and/or method for reducing fuel consumption in a rotary kiln. In some embodiments, reduced fuel consumption is achieved by blowing air from an air lance into a bed of calcining material.

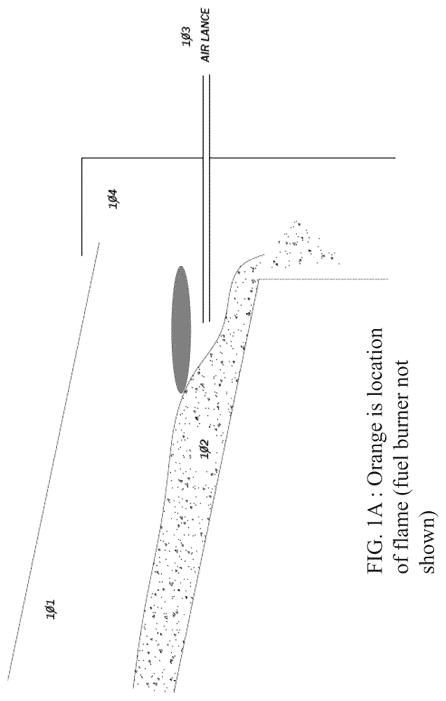

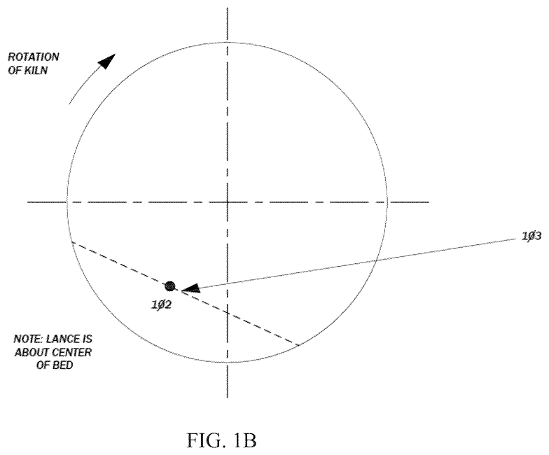

FIG. 1A illustrates a cross-sectional side view of one embodiment as disclosed herein comprising an inclined rotatable drum 101 with a bed of material 102 disposed inside the drum, a kiln hood 104, and an air lance 103. In some embodiments, the inclined drum rotates which results in the bed of material 102 moving down the drum 101 toward kiln hood 104. As material from the bed of material 102 drops out of the rotating drum 101, it falls down the chute at base on kiln hood 104 into a cooling chamber (not shown). As show in FIG. 1A, in some embodiments an air lance 103 having a first end and a second end is positioned with the first end proximal to the bed of material near the low end of the drum. In some embodiments, air is blown through the air lance 103 out of the first end and into the bed of material 102.

In some embodiments, granular petcoke is fed into the raised end of the inclined drum and discharged at the low end. In some embodiments, the inclined drum has a slope of, for example, ¼ inch to 1 inch per foot, wherein the granular petcoke travels as a continuous bed inside the rotating inclined drum. In some embodiments, rotation of the inclined drum may be driven by conventional means, such as a pinion and ring gear arrangement, and may be adjusted for speed of rotation. In some embodiments, the speed of rotation of the drum may be 0.5 rotations per minute (rpm) to 2 rpm. In some embodiments, the drum diameter may be 8 feet to 16 feet.

In some embodiments, as the bed of material 102 (e.g., petcoke) travels from the raised end of the inclined drum 101 to the low end of the inclined drum 101, it is exposed to high temperatures applied by burning fuel. In some embodiments, the flame from burning fuel is located at the approximate surface of the bed of material. See, e.g., FIG. 1A. In some embodiments, application of heat by burning of fuel may be performed only during initial operation of the kiln to achieve calcining temperatures, after which time burning of volatile compounds driven from the bed of material is sufficient to maintain calcining temperature. In some embodiments, air is delivered to the bed of material via an air lance 103 positioned proximate to or inside the included drum.

FIG. 1B illustrates a cross-sectional front view of one embodiment as disclosed herein comprising an inclined rotatable drum 101 with a bed of material 102 disposed inside the rotatable drum and an air lance 103. In some embodiments the drum rotates around an axis, which results in the bed of material slightly rising up the wall of the drum 101 relative to the direction of force of gravity. As shown in FIG. 1B, in some embodiments the first end of the air lance 103 is positioned at the approximate center of the top surface of the bed as it rises up the rotating drum 101. In some embodiments, the first end of the air lance may be less than 30 inches, less than 20 inches, or less than 10 inches from the bed of material. In some embodiments, the first end of the air lance is between 0 inches to 18 inches from the bed of material. In some embodiments, the first end of the air lance is between 6 inches to 18 inches from the bed of material. In some embodiments, air is injected in a direction parallel to the kiln axis. In some embodiment the air injection is in a direction up to 10 degrees relative to the kiln axis in any direction.

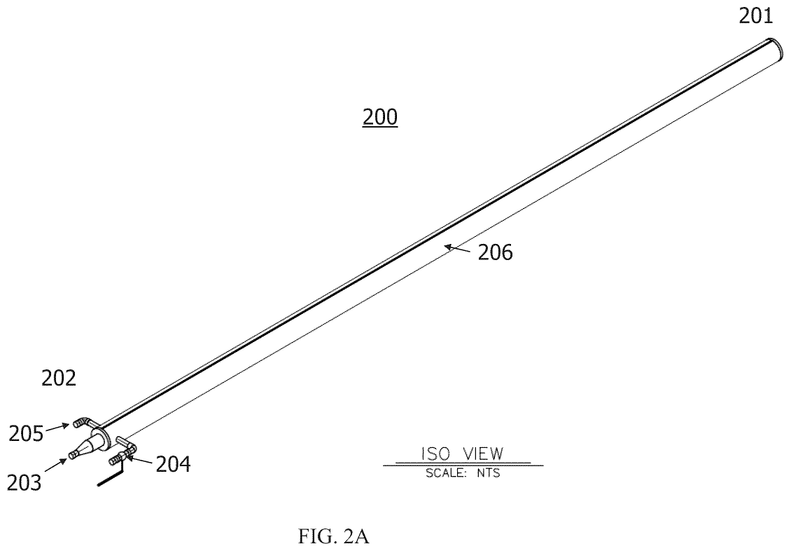

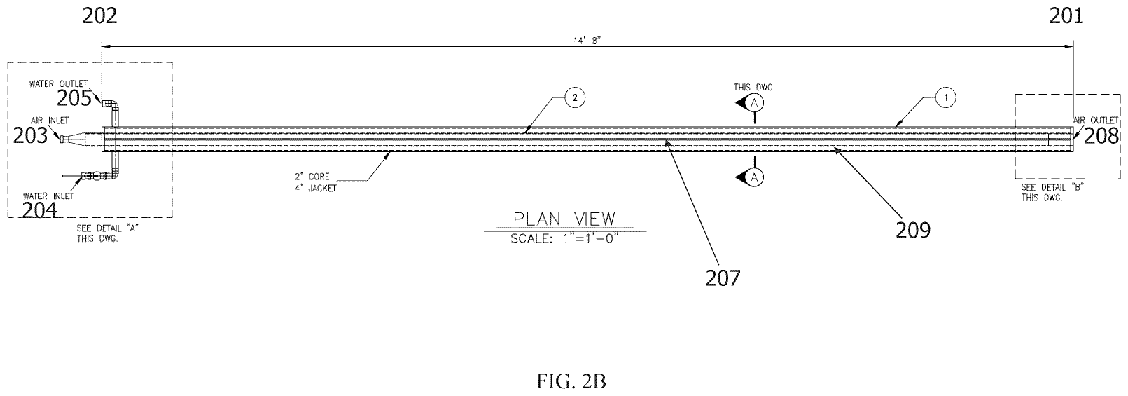

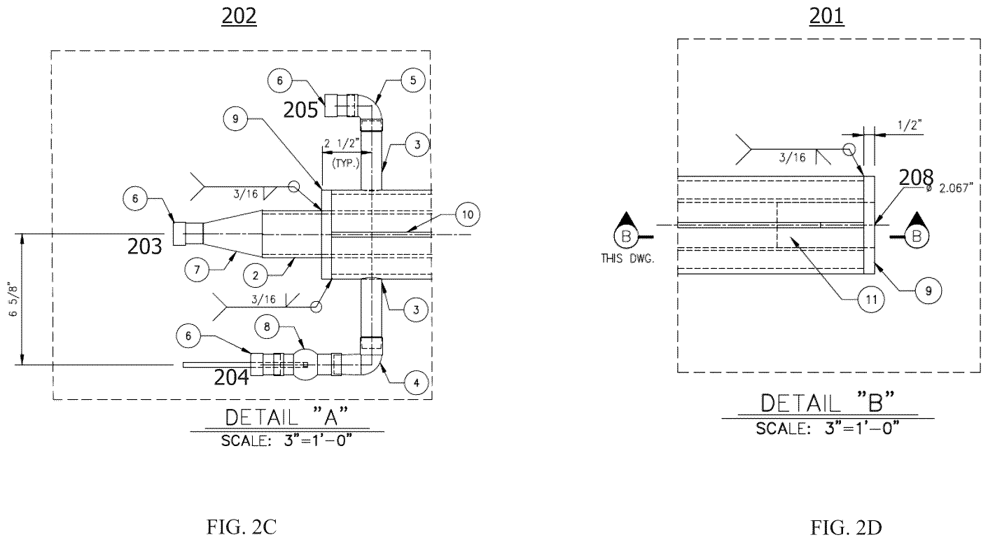

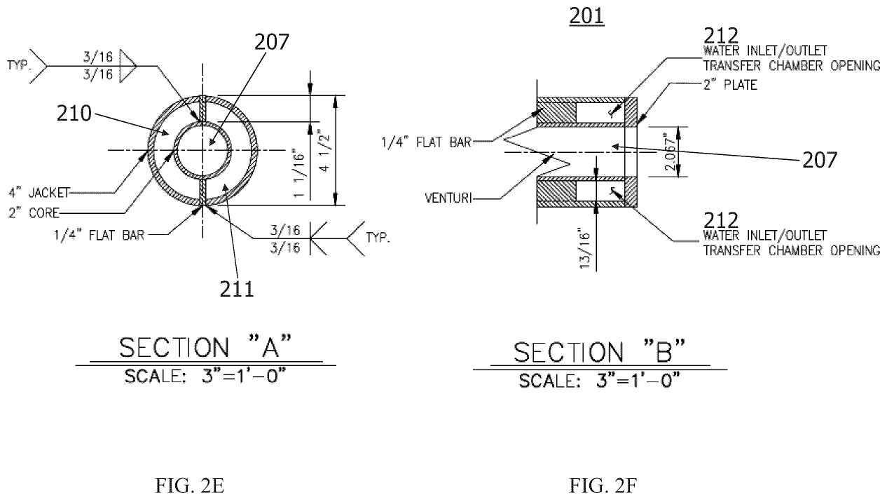

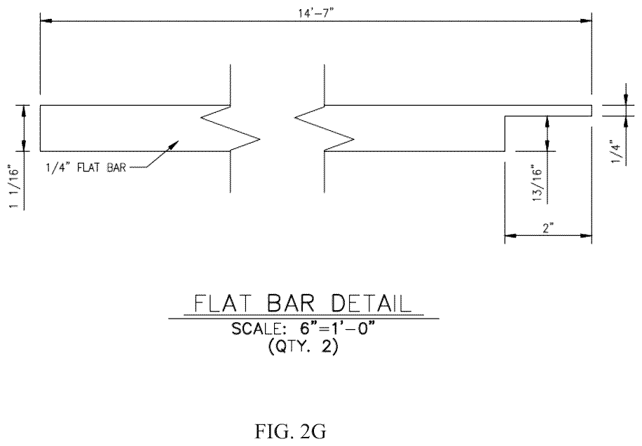

FIG. 2A illustrates a perspective view of one embodiment of an air lance 200 as disclosed herein. In some embodiments, the air lance 200 comprises a first end 201 and a second end 202. In some embodiments, the second end 202 receives air from an air inlet 203, which then travels through the air lance 200 and is emitted from the first end 201. In some embodiments, the second end 202 also comprises a water inlet 204 and a water outlet 205 for water cooling of the air lance while inserted into a hot kiln. In some embodiments, water enters the inlet 204, travels into the body of the air lance 206, and then is emitted from the water outlet 205. In some embodiments, the water is effective to transfer heat away from the air lance 200.

FIG. 2B illustrates a cross sectional side view of one embodiment of an air lance 200 as disclosed herein. In some embodiments, the air lance 200 comprises a first end 201 and a second end 202. In some embodiments, the second end 202 receives air from an air inlet 203, which then travels through the air lance 200 through an inner chamber 207 defined by the walls of the air lance 200 and emitted from the first end 201 through an air outlet 208. In some embodiments, the second end 202 also comprises a water inlet 204 and a water outlet 205 for water cooling of the air lance while inserted into a hot kiln. In some embodiments, water enters the inlet 204, travels into the body of the air lance 206 through one or more outer chambers 209 defined by the walls of the air lance 200, and then is emitted from the water outlet 205. In some embodiments, the water is effective to transfer heat away from the air lance 200. A zoomed in view of the second end is shown in FIG. 2C and a zoomed in view of the first end is shown in FIG. 2D.

FIG. 2E shows a cross-sectional front view of one embodiment of the body 206 of the air lance 200 as disclosed herein. In some embodiments, the air lance comprises an inner chamber 207 through which air can travel, and one or more outer chambers 210, 211, through which water can travel, where chamber 210 and 211 are connected. FIG. 2F shows a cross-sectional side view of one embodiment of the first end 201 of the air lance as disclosed herein. In some embodiments, the first end comprises an opening 212 that is effective to transfer water from one outer chamber (e.g., 210) to another outer chamber (e.g. 211).

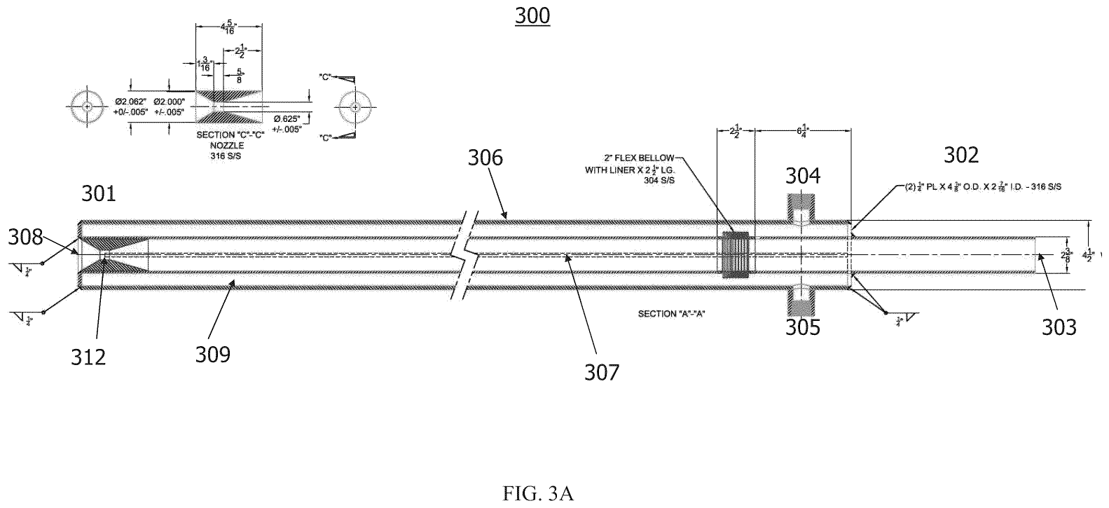

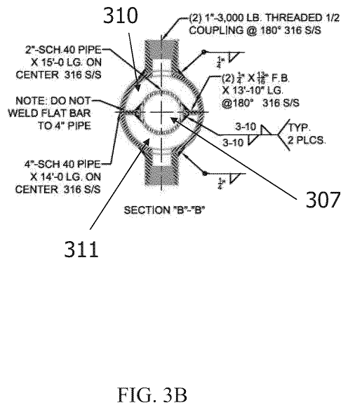

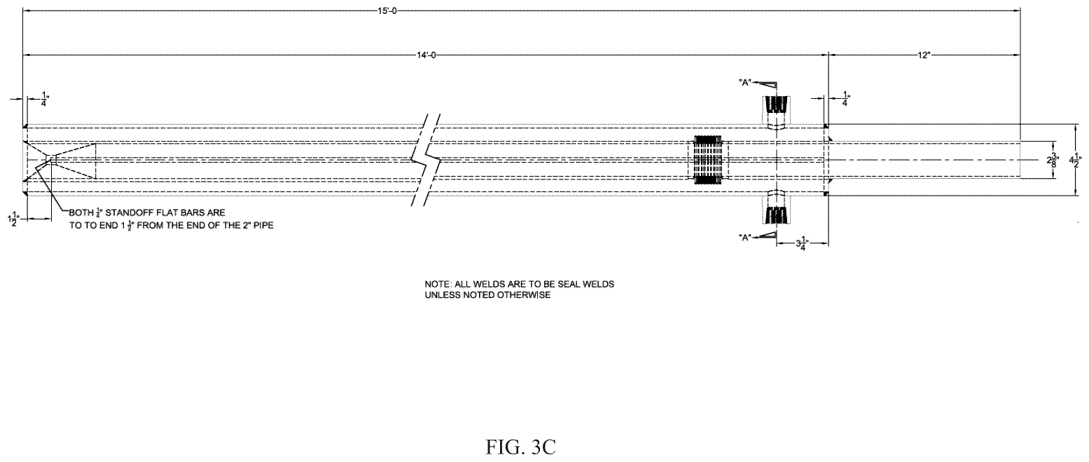

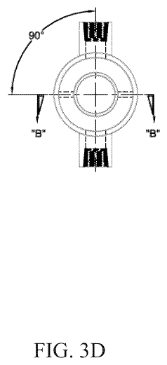

FIG. 3A shows a cross-sectional side view of one embodiment of an air lance 300 as disclosed herein having a first end 301 and a second end 302. In some embodiments, the second end 302 receives air from an air inlet 303, which then travels through the air lance 300 through an inner chamber 307 defined by the walls of the air lance 300 and emitted from the first end 301 through an air outlet 308. In some embodiments, the second end 302 also comprises a water inlet 304 and a water outlet 305 for water cooling of the air lance while inserted into a hot kiln. In some embodiments, water enters the inlet 304, travels into the body of the air lance 306 through one or more outer chambers 309 defined by the walls of the air lance 300, and then is emitted from the water outlet 305. In some embodiments, the water is effective to transfer heat away from the air lance 300.

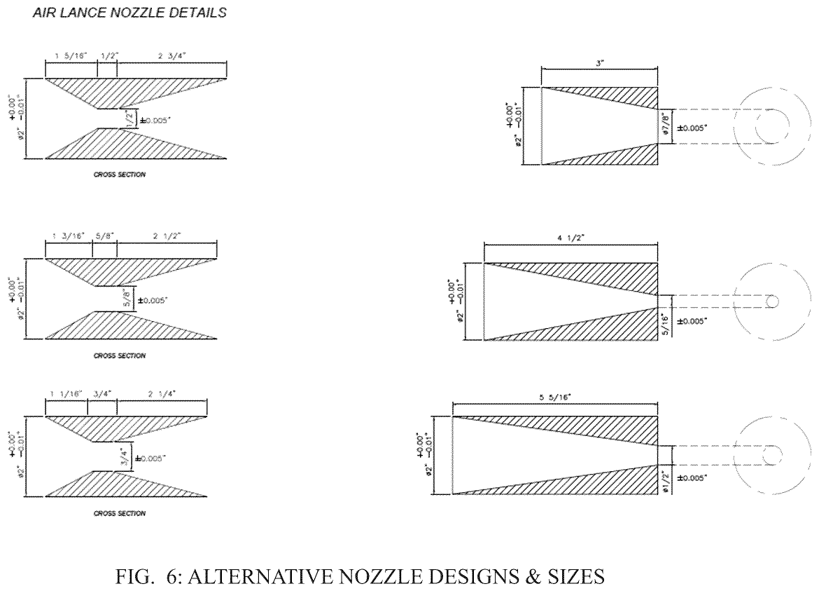

In some embodiments, the air lance 300 comprises a constriction 312 in the inner chamber at the first end 301. In some embodiments, the constriction 312 is effective to increase the velocity of air exiting the first end 301 of the air lance 300. In some embodiments, the air lance as disclosed herein has a constriction as shown in FIG. 6.

FIG. 3B shows a cross-sectional front view of one embodiment of the body 306 of the air lance 200 as disclosed herein. In some embodiments, the air lance comprises an inner chamber 307 through which air can travel, and one or more outer chambers 310, 311, through which water can travel. FIG. 3C shows a cross-sectional side view of one embodiment of the body of the air lance as disclosed herein, showing overall length of about 15 feet. In some embodiments, the overall length of the air lance is between 10 feet and 20 feet in length. In some embodiments, the overall length of the air lance is effective to place the first end in proximity to the bed of material while keeping the air inlet away from the high temperatures of the kiln.

FIG. 6 show a cross-sectional side view of various embodiments of the end of the air lance from which air is ejected (e.g. 301 first end, 201 first end) comprising a nozzle. In some embodiments, the nozzle comprises walls defining a constriction (FIG. 6, left side) through which air travels. In some embodiments, the walls defining the constriction are continuous with the walls defining an inner chamber (e.g. 307 inner chamber, 207 inner chamber through which air travels). In some embodiments, the constriction is between ¼ inch and 1 inch wide. In some embodiments, the constriction is ½ inch wide. In some embodiments, the constriction is ⅝ inch wide. In some embodiments, the constriction is ¾ inch wide. In some embodiments, the constriction is as long as it is wide. In some embodiments, the constriction is between ¼ inch and 1 inch long. In some embodiments, the constriction is ½ inch long. In some embodiments, the constriction is ⅝ inch long. In some embodiments, the constriction is ¾ inch long. In some embodiments, the opening from which air exits is about 2 inches.

In some embodiments, the nozzle comprises walls defining a frustoconical shape (FIG. 6 right side). In some embodiments, the walls defining the frustoconical shape are continuous with the walls defining an inner chamber (e.g. 307 inner chamber, 207 inner chamber through which air travels). In some embodiments, the narrow end of the frustoconical shape is between ¼ inch and 1 inch wide. In some embodiments, the narrow end of the frustoconical shape is ½ inch wide. In some embodiments, the narrow end of the frustoconical shape is ⅞ inch wide. In some embodiments, the narrow end of the frustoconical shape is 5/16 inch wide. In some embodiments, the overall length of the frustoconical shape is between 2 inches and 8 inches. In some embodiments, the overall length of the frustoconical shape is 3 inches. In some embodiments, the overall length of the frustoconical shape is 4 and ½ inches. In some embodiments, the overall length of the frustoconical shape is 5 and 5/16 inches. In some embodiments, the opening from which air exits is about 2 inches.

The scope of the present disclosure is not intended to be limited by the specific disclosures of embodiments in this section or elsewhere in this specification and may be defined by claims as presented in this section or elsewhere in this specification or as presented in the future. The language of the claims is to be interpreted broadly and not limited to the examples described in the present specification or during the prosecution of the application, which examples are to be construed as non-exclusive.

### EXAMPLES

EXAMPLE 1. The air lance according to one embodiment as disclosed herein was tested over a period of 20 days to determine its effect on the amount of gas needed to calcine green petcoke. The air lance of FIGS. 2A/2B were tested for integrity of the lance inside the kiln. Briefly, air lance 200 was used, with air pressure of about 20 psig, and water about 13 gallons/minute. The lance was inserted for 4-52 hrs. During several days, gas reduction of 2-8,000 CFH (cubic feet per hour of gas flow) was seen, with no quality issues.

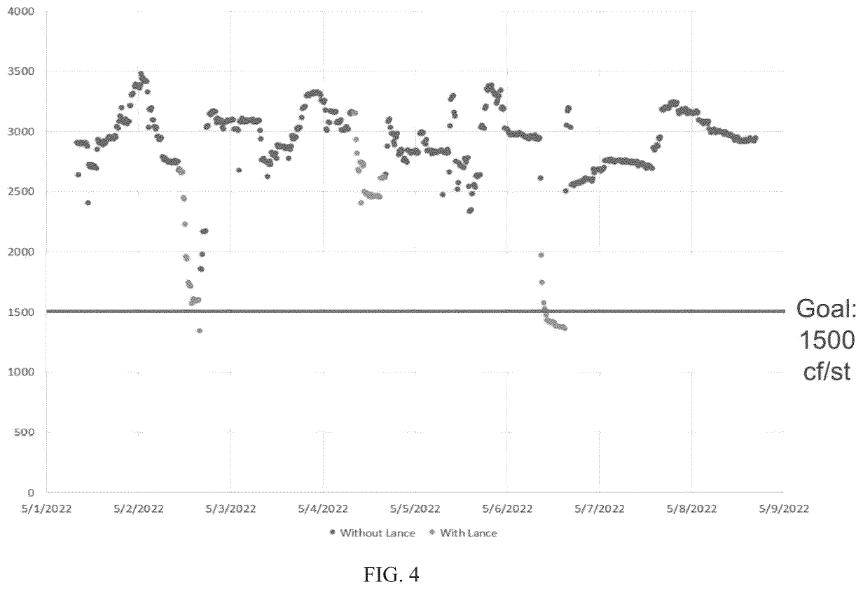

EXAMPLE 2. The air lance of FIGS. 2A/2B was inserted into the kiln for 4-8 hours with air injected at a pressure of 20 psig on each of days May 2, May 4, and May 6 of the experiment. The tip of the lance was positioned approximately 6 inches from the center of the bed of petcoke at an angle parallel to ground, relative to the axis of rotation of the inclined drum. As shown in FIG. 4, on day 2 after insertion of the lance and injection of air, there was a steady drop in the required gas consumption needed to complete calcination of the petcoke, and there was no quality deterioration as defined by petroleum coke real density. Specifically, the required gas consumption dropped from a high of about 2,700 cf/st (cubic feet gas per short ton of coke product) to a low of about 1,300 cf/st. On day 4 of the experiment, the required gas consumption dropped from a high of about 3,200 cf/st to a low of about 2,400 cf/st. On day 6 of the experiment, the required gas consumption dropped from a high of about 2,000 cf/st to a low of about 1,300 cf/st. By contrast, when the air lance was not employed, gas consumption generally was maintained between 3,500 cf/st and 2,300 cf/st. Thus, it was surprisingly found that the use of the air lance was capable of significantly reducing the amount of natural gas required to achieve complete calcination of green petcoke.

EXAMPLE 3. The air lance according to one embodiment as shown in FIG. 2A/2B herein was tested over a period of about 25 days to determine its effect on the amount of gas needed to calcine green petcoke. Briefly, the air lance 200 was used, and it was kept inside the kiln for several days at a time.

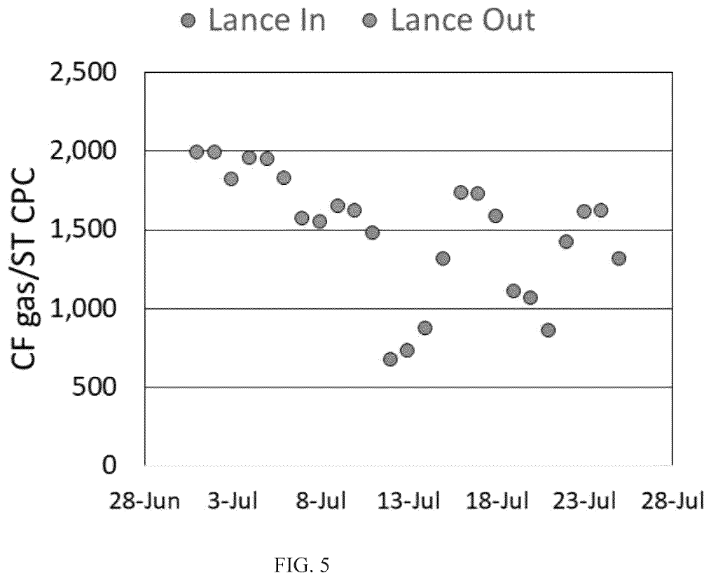

The air lance was inserted into the kiln for 5 days followed by a 2 day pause (weekend). Air was injected at a pressure of 20 psig on each day that the air lance was inserted in the kiln. The tip of the lance was positioned approximately 6 inches from where the coke discharges from the rotating drum at a slight angle relative to the axis of rotation of the inclined drum. As shown in FIG. 5, at the first time period after insertion of the lance and injection of air, there was a significant drop in the required gas consumption needed to complete calcination of the petcoke. Specifically, the required gas consumption dropped from a high of about 1,500 cf gas/st CPC (cubic feet of gas per short ton of calcined coke product) to a low of about 700 cf/st. At the second time period after insertion of the air lance and injection of air, there was a drop from a high of about 1,600 cf gas/ST CPC to a low of about 900 CF gas/ST CPC. By contrast, when the air lance was not employed, gas consumption generally was maintained between 2,000 cf/st CPC and 1,500 cf/st CPC. Thus, it was surprisingly found that the use of the air lance was capable of significantly reducing the amount of natural gas required to achieve complete calcination of green petcoke.

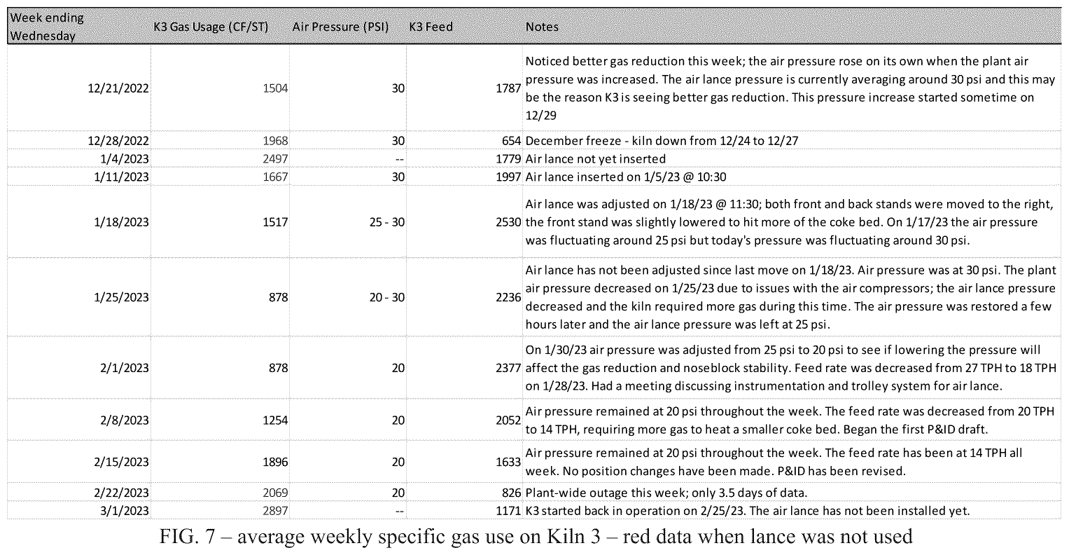

EXAMPLE 4. The lance 200 was used for several weeks this year, with average weekly gas usage on column 2 on FIG. 7. Data in red was during weeks when the lance was not used. These data show gas reduction (defined as cubic feet of gas, per ton of product produced) when the lance was used. The variance in data is due to pressure and location fluctuations. It was surprisingly found that the use of the air lance was able to significantly reduce gas usage over several weeks of trials.

Although illustrative embodiments of the present disclosure have been described herein, it should be understood that the disclosure is not limited to those described, and that various other changes or modification may be made by one of ordinary skill in the art without departing from the scope or spirit of the invention.

What is claimed is:

1. A system for reducing gas consumption in a rotary kiln comprising:
an inclined drum having an upper end and a lower end, the drum configured to rotate around an axis and convey a bed of material from the upper end to the lower end along the axis; and
an air lance comprising a wall defining an interior space, a first end, and a second end, the first end of the air lance positioned proximate to the bed of material and effective to inject air from the interior space into the bed of material, the second end positioned distal to the bed of material and effective to transfer air to the interior space;
wherein the first end of the air lance is about 0 inches to 18 inches from where the coke product discharges from the kiln.

2. The system of claim 1, wherein the air lance is water-cooled.

3. The system of claim 1, wherein the first end of the air lance is effective to receive air at a pressure of about 10-30 psig.

4. The system of claim 1, wherein the first end of the air lance is effective to receive air at a pressure of about 20 psig.

5. The system of claim 1, wherein the air lance comprises one or more bellows located in the interior space of the air lance.

6. The system of claim 1, wherein the air lance comprises a constriction of the interior space at the first end.

7. The system of claim 1, wherein the air lance comprises a water inlet, walls defining a second interior space, and a water outlet, wherein the second interior space is effective to receive water from the water inlet and emit water from the water outlet.

8. The system of claim 1, wherein the air lance is effective to inject air into the bed of material while the inclined drum rotates.

9. The system of claim 8, wherein the inclined drum is effective to drop material from the bed of material out of the inclined drum after being contacted with the injected air.

10. The system of claim 1, further comprising a heat source positioned inside the drum, wherein the heat source is effective to calcine the bed of material.

11. The system of claim 10, wherein the heat source is a flame fueled by a gas and air mixture.

12. The system of claim 10, wherein the injection of air into the bed of material is effective to reduce the amount of gas required to calcine the bed of material by greater than 10% relative to the amount of gas required to calcine without injection of air.

13. The system of claim 10, wherein the injection of air into the bed of material is effective to reduce the amount of gas required to calcine the bed of material by greater than 15% relative to the amount of gas required to calcine without injection of air.

14. The system of claim 10, wherein the injection of air into the bed of material is effective to reduce the amount of gas required to calcine the bed of material by greater than 20% relative to the amount of gas required to calcinate without injection of air.

15. The system of claim 1, wherein the air is atmospheric air.

16. The system of claim 1, wherein the bed of material is petroleum coke.

17. The system of claim 2, wherein the water cooled air lance is cooled with approximately 13 gallons per minute of water.

18. The system of claim 1, wherein the air lance extends into the rotary kiln by at least 5 feet.

19. The system of claim 1, wherein the air lance extends into the rotary kiln by at least 5.5 feet.

20. The system of claim 1, wherein the air lance extends into the rotary kiln by at least 6 feet and up to 8 feet.

21. An apparatus for reducing gas consumption in a rotary kiln comprising:
an inclined drum having an upper end and a lower end, the drum configured to rotate around an axis and convey a bed of material from the upper end to the lower end along the axis; and
an air lance comprising a wall defining an interior space, a first end, and a second end, the first end of the air lance positioned proximate to the bed of material and effective to inject air from the interior space into the bed of material, the second end positioned distal to the bed of material and effective to transfer air to the interior space;
wherein the first end of the air lance is about 0 inches to 18 inches from where the coke product discharges from the rotating kiln.

22. The apparatus of claim 21, wherein the air lance is water-cooled.

23. The apparatus of claim 21, wherein the first end of the air lance is effective to receive air at a pressure of about 10-30 psig.

24. The apparatus of claim 21, wherein the first end of the air lance is effective to receive air at a pressure of about 20 psig.

25. The apparatus of claim 21, wherein the air lance comprises one or more bellows located in the interior space of the air lance.

26. The apparatus of claim 21, wherein the air lance comprises a constriction of the interior space at the first end.

27. The apparatus of claim 21, wherein the air lance comprises a water inlet, walls defining a second interior space, and a water outlet, wherein the second interior space is effective to receive water from the water inlet and emit water from the water outlet.

28. The apparatus of claim 21, wherein the air lance is effective to inject air into the bed of material while the inclined drum rotates.

29. The apparatus of claim 28, wherein the inclined drum is effective to drop material from the bed of material out of the inclined drum after being contacted with the injected air.

30. The apparatus of claim 21, further comprising a heat source positioned inside the drum, wherein the heat source is effective to calcine the bed of material.

31. The apparatus of claim 30, wherein the heat source is a flame fueled by a gas and air mixture.

32. The apparatus of claim 30, wherein the injection of air into the bed of material is effective to reduce the amount of gas required to calcine the bed of material by greater than 10% relative to the amount of gas required to calcine without injection of air.

33. The apparatus of claim 30, wherein the injection of air into the bed of material is effective to reduce the amount of gas required to calcine the bed of material by greater than 15% relative to the amount of gas required to calcinate without injection of air.

34. The apparatus of claim 30, wherein the injection of air into the bed of material is effective to reduce the amount of gas required to calcine the bed of material by greater than 20% relative to the amount of gas required to calcinate without injection of air.

35. The apparatus of claim 21, wherein the air is atmospheric air.

36. The apparatus of claim 21, wherein the bed of material is petroleum coke.

37. The apparatus of claim 22, wherein the water cooled air lance is cooled with approximately 13 gallons per minute of water.

38. The apparatus of claim 21, wherein the air lance extends into the rotary kiln by at least 5 feet.

39. The apparatus of claim 21, wherein the air lance extends into the rotary kiln by at least 5.5 feet.

40. The apparatus of claim 21, wherein the air lance extends into the rotary kiln by at least 6 feet.

41. A method of reducing gas consumption of a rotary kiln, the method comprising:
providing an air lance proximate to an inclined drum,
wherein the inclined drum comprises an upper end and a lower end and is configured to rotate around an axis to convey a bed of material from the upper end to the lower end along the axis; and
wherein the air lance comprises a wall defining an interior space, a first end, and a second end, the first end of the air lance positioned proximate to the bed of material and effective to inject air from the interior space into the bed of material, the second end positioned distal to the bed of material and effective to transfer air to the interior space, wherein the first end of the air lance is about 0 inches to 18 inches from where the coke product discharges from the rotating kiln; and
injecting air from the air lance into the bed of material while simultaneously rotating the inclined drum to convey the bed of material from the upper end to the lower end along the axis.

42. The method of claim 41, further comprising the step of water cooling the air lance.

43. The method of claim 41, wherein the first end of the air lance is effective to receive air at a pressure of about 10-30 psig.

44. The method of claim 41, wherein the first end of the air lance is effective to receive air at a pressure of about 20 psig.

45. The method of claim 41, wherein the air lance comprises one or more bellows located in the interior space of the air lance.

46. The method of claim 41, wherein the air lance comprises a constriction of the interior space at the first end.

47. The method of claim 41, wherein the air lance comprises a water inlet, walls defining a second interior space, and a water outlet, wherein the second interior space is effective to receive water from the water inlet and emit water from the water outlet.

48. The method of claim 41, wherein the inclined drum is effective to drop material from the bed of material out of the inclined drum after being contacted with the injected air.

49. The method of claim 41, further comprising the step of providing a heat source inside the drum, wherein the heat source is effective to calcine the bed of material.

50. The method of claim 49, wherein the heat source is a flame fueled by a gas and air mixture.

51. The method of claim 41, wherein the injection of air into the bed of material is effective to reduce the amount of gas required to calcine the bed of material by greater than 10% relative to the amount of gas required to calcine without injection of air.

52. The method of claim 41, wherein the injection of air into the bed of material is effective to reduce the amount of gas required to calcine the bed of material by greater than 15% relative to the amount of gas required to calcine without injection of air.

53. The method of claim 41, wherein the injection of air into the bed of material is effective to reduce the amount of gas required to calcine the bed of material by greater than 20% relative to the amount of gas required to calcine without injection of air.

54. The method of claim 41, wherein the air is atmospheric air.

55. The method of claim 41, wherein the bed of material is petroleum coke.

56. The method of claim 42, wherein the water cooled air lance is cooled with approximately 13 gallons per minute of water.

57. The method of claim 41, wherein the air lance extends into the rotary kiln by at least 5 feet.

58. The method of claim 41, wherein the air lance extends into the rotary kiln by at least 5.5 feet.

59. The method of claim 41, wherein the air lance extends into the rotary kiln by at least 6 feet, and up to 8 feet

60. The system of claim 6, wherein the constriction is between ¼ inch and 1 inch wide.

61. The system of claim 6, wherein the constriction is between ¼ inch and 1 inch long.

62. The system of claim 6, wherein the constriction is as wide as it is long.

63. The system of claim 1, wherein the air lance comprises interior walls defining a frustoconical shape at the interior of the first end.

64. The system of claim 63, wherein the narrow end of the frustoconical shape is between ¼ inch and 1 inch wide.

65. The system of claim 63, wherein the overall length of the frustoconical shape is between 2 inches and 8 inches.

66. The system of claim 63, wherein the opening from which air exits the first end is about 2 inches.
